(19) United States
(12) Patent Application Publication
(10) Pub. No.: US 2005/0210528 A1
(43) Pub. Date: Sep. 22, 2005

(54) Network AV system, controller and program therefor

(76) Inventor: Toshinobu Sano, Neyagawa-shi (JP)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 11/066,074

(22) Filed: Feb. 25, 2005

(30) Foreign Application Priority Data
Mar. 19, 2004 (JP) 2004-79345
Sep. 1, 2004 (JP) 2004-254224

(51) Int. Cl. H04N 7/173; H04N 7/08; H04N 7/06; H04N 7/04; H04N 7/16

(52) U.S. Cl. 725/115; 725/91; 725/145; 725/116

(57) ABSTRACT

A controller 20 has program schedules PS1 to PSn associated with clients CL1 to CL3. Each of the program schedules PS1 to PSn includes a plurality of programs each associated with a different reproduction time slot and including a list of music data MD to be reproduced in that reproduction time slot. The audio clients CL1 to CL3 are instructed to reproduce the music data MD according to the program schedules PS1 to PSn. In response to the instruction, the audio clients CL1 to CL3 request content items. In response to the request, the server 10 distributes content items to the audio clients CL1 to CL3. Each of the clients CL1 to CL3 reproduces music pieces based on the music data distributed from the server 10.

### BACKGROUND OF THE INVENTION

1. Field of the Invention

The present invention relates to a network AV system and a controller, and more particularly to a network AV system including a server and one or more clients connectable to the server, and a controller for use in such a network AV system.

2. Description of the Related Art

Network AV systems based on a client/server architecture are already in use. International Publication WO03/102919 discloses a network AV system including a server storing a large number of content items, and a client connected to the server via a LAN (Local Area Network). The client requests the server to provide a content item of interest, in response to which the server sends back the requested content item to the client. The client reproduces a sound and/or video image based on the content item from the server.

The network AV system also has an alarm function of starting the reproduction of a sound and/or video image based on a predetermined content item at a predetermined time, and a sleep function of terminating the reproduction of a sound and/or video image at a predetermined time. Therefore, a reproduction start time can be set by using the alarm function and a reproduction finish time by using the sleep function so that a predetermined sound and/or video image can be reproduced starting from, and ending at, each specified time.

However, the network AV system does not have a function that allows the user to specify a plurality of sets of a reproduction start time and a reproduction finish time. Therefore, in order to reproduce a predetermined sound or video image in more than one time slots (e.g., 10:00-11:00 and 19:00-20:00), a user operation for starting/terminating the reproduction will be required in either one of the time slots.

### SUMMARY OF THE INVENTION

It is therefore an object of the present invention to provide a network AV system with which it is possible to reproduce a sound and/or video image based on a content item or content items in a plurality of time slots without requiring a user operation at the reproduction start time or at the reproduction finish time.

A network AV system of the present invention includes: a server having a content storage section for storing a plurality of content items; one or more clients connectable to the server; a program schedule storage section for storing one or more program schedules each including a plurality of program information, the plurality of program information each including content information about a content item and a reproduction time slot associated with the content information; an instruction section for giving an instruction to reproduce a content item according to the program schedule; and one or more reproduction sections for reproducing the content item in response to the instruction, wherein the server further includes a distribution section for distributing the content items to the one or more reproduction sections. The program information storage section, the instruction section and the reproduction section may be present at any position in the network AV system, and they may be included in the server or in the client. The content to be requested and distributed may be sound (music or voice) data, video data, still image data, or any combination thereof.

In the network AV system of the present invention, the server sends a content item to the reproduction section and the reproduction section reproduces a sound and/or video image based on the received content item according to the content information associated with the reproduction time slot in the program information of the program schedule. Information about the content item to be reproduced is registered in the program schedule for each reproduction time slot. Therefore, with the network AV system, it is possible to reproduce sound and/or video images based on content items in a plurality of time slots according to the program schedule. When the content items are reproduced, the user does not need to manually start or end the reproduction at the reproduction start time or the reproduction finish time.

In a preferred embodiment, the network AV system further includes a section for associating a predetermined program schedule among the plurality of program schedules with one or more predetermined reproduction sections among the plurality of reproduction sections, wherein the instruction section gives an instruction to reproduce a content item to the one or more predetermined reproduction sections associated with the program schedule.

With the network AV system, each reproduction section reproduces a sound and/or video image based on a content item according to the program schedule associated with the reproduction section. The program schedule to be associated with the reproduction section is arbitrarily selected from among a plurality of program schedules. Therefore, with the network AV system, a predetermined reproduction section can reproduce a sound and/or video image according to a predetermined program schedule. Moreover, each reproduction section can reproduce a sound and/or video image according to a different program schedule.

In a preferred embodiment, the network AV system further includes: a section for determining whether or not a current time is included in the reproduction time slot of a program schedule; and a section for determining whether or not each reproduction section associated with the program schedule is performing a reproduction process, wherein when it is determined that the current time is included in the reproduction time slot and the reproduction section is not performing a reproduction process, the instruction section gives an instruction to reproduce a content item according to the content information associated with the reproduction time slot.

The network AV system refers to the current time and the reproduction time slot to determine whether or not there is a content item to be reproduced in the program schedule. If there is a content item to be reproduced, all of the reproduction sections associated with the program schedule are checked as to whether or not they are performing a reproduction process. If there is a reproduction section that is not performing a reproduction process, the reproduction section is instructed to reproduce the content item.

A reproduction section that has been newly associated with a program schedule is not performing a reproduction process immediately after it is associated with the program schedule. However, with the determination process described above, the reproduction section will start reproducing a sound and/or video image based on a content item to be reproduced. Thus, even a reproduction section that is newly associated with a program schedule can quickly start reproducing a sound and/or video image based on a content item.

In a preferred embodiment, the network AV system further includes: a program information creating section for creating the program information; and a program schedule registering section for registering the created program information in the program schedule. Note that “creating” as used herein also includes “changing”, i.e., creating new program information and replacing old program information with the new program information.

With the network AV system, it is possible to create program information as desired by the user. In other words, the content information and the reproduction time slot of the program information can be freely determined. Thus, it is possible to reproduce a sound and/or video image based on an intended content item in an intended time slot. Moreover, the network AV system registers the created program information in an intended program schedule. Thus, different program information can be registered for each program schedule.

Furthermore, the network AV system can create new program information and replace old program information with the new program information. In other words, the program information can be changed. Then, the network AV system reproduces a sound and/or video image according to content information associated with a reproduction time slot of the new program information. Thus, even if program information is changed during a reproduction process by a reproduction section, the reproduction section can continue the reproduction process according to the new program information.

In a preferred embodiment, the network AV system further includes a content information creating section for creating the content information by listing one or more selected content items among all the content items stored in the content storage section.

With the network AV system, it is possible to freely select content items from among a plurality of content items stored in the content storage section, and create content information being a list of the selected content items. Thus, it is possible to easily create content information based on a plurality of content items in the content storage section.

In a preferred embodiment, the instruction section gives an instruction to reproduce the content items listed in the content information in an order the content items are listed.

With the network AV system, the reproduction section reproduces sound and/or video images based on content items in the order they are listed in the content information. Therefore, by listing content items in an intended order when creating the content information, it is possible to freely determine the order in which sound and/or video images are reproduced based on the content items.

In a preferred embodiment, the program schedule further includes special program information including content information and a reproduction start time associated with the content information; and when a current time has reached the reproduction start time, the instruction section gives an instruction to reproduce a content item according to content information that is associated with the reproduction start time, irrespective of whether or not the reproduction section is reproducing a content item according to content information that is associated with the reproduction time slot.

With the network AV system, it is possible to instruct the reproduction section to reproduce a special program at any time. Specifically, even if a reproduction section is currently reproducing a program according to program information, a special program can be reproduced by suspending the reproduction of the regular program.

In a preferred embodiment, the network AV system further includes a completion determination section for determining whether or not the reproduction section has completely reproduced a content item based on content information that is associated with the reproduction start time, wherein when the completion determination section determines that the content item has been completely reproduced, the instruction section gives an instruction to reproduce a content item according to content information whose reproduction time slot includes the current time.

With the network AV system, even if a reproduction section reproduces a special program by suspending the reproduction of a regular program, the reproduction section can resume the reproduction of the regular program after the reproduction of the special program is completed.

In a preferred embodiment, the content information is a list of content items; the instruction section gives an instruction to reproduce the list of content items in an order the content items are listed; the network AV system further includes an identification section, wherein when the current time has reached the reproduction start time of the special program while the reproduction section is reproducing a content item according to content information of the regular program whose reproduction time slot includes the current time, the identification section identifies the content item being reproduced by the reproduction section; and if the completion determination section determines that the content item has been completely reproduced and if the current time is included in the reproduction time slot, the instruction section gives an instruction to successively reproduce content items starting from the identified content item.

When a special program is reproduced by suspending a regular program being reproduced, the identification section identifies the content item being suspended. Therefore, after the reproduction of the special program is completed, the reproduction section can resume the reproduction of the regular program starting from the suspended content item.

### BRIEF DESCRIPTION OF THE DRAWINGS

FIG. 1 is a functional block diagram showing a configuration of a network AV system according to a first embodiment of the present invention.

FIG. 2 is a functional block diagram showing a configuration of the server shown in FIG. 1.

FIG. 3 is a functional block diagram showing a configuration of the controller shown in FIG. 1.

FIG. 4 schematically shows a user interface displayed on a display shown in FIG. 3.

FIG. 5 is a functional block diagram showing a configuration of the audio client shown in FIG. 1.

FIG. 6 is a flow chart showing a connection process of the network AV system shown in FIG. 1.

FIG. 7 is a flow chart showing a program schedule updating process of the controller shown in FIG. 1.

FIG. 8 schematically shows a user interface displayed in step S200 shown in FIG. 7.

FIG. 9 is a flow chart showing in detail the operation of step S204 shown in FIG. 7.

FIG. 10 is a flow chart showing a program schedule selection process of the controller shown in FIG. 1.

FIG. 11 is a flow chart showing a program instruction process of the controller shown in FIG. 1.

FIG. 12 is a flow chart showing in detail the operation of step S403 shown in FIG. 11.

FIG. 13 is a flow chart showing in detail the operation of step S5000 shown in FIG. 12.

FIG. 14 is a flow chart showing in detail the operation of step S6000 shown in FIG. 12.

FIG. 15 is a flow chart showing a reproduction operation of the network AV system shown in FIG. 1.

FIG. 16 is a flow chart showing in detail the operation of steps S500 and S510 shown in FIG. 15.

FIG. 17 is a flow chart showing another reproduction operation of the network AV system shown in FIG. 1.

FIG. 18 is a flow chart showing a program instruction process of a network AV system according to a second embodiment of the present invention.

FIG. 19 is a flow chart showing in detail the operation of step S700 shown in FIG. 18.

FIG. 20 is a flow chart showing in detail the operation of step S706 shown in FIG. 19.

FIG. 21 is a flow chart showing in detail the operation of step S800 shown in FIG. 18.

FIG. 22 is a flow chart showing a reproduction operation of the network AV system according to the second embodiment of the present invention.

FIG. 23 is a flow chart showing in detail the operation of steps S510 and S560 shown in FIG. 22.

### DETAILED DESCRIPTION OF THE PREFERRED EMBODIMENTS

Preferred embodiments of the present invention will now be described with reference to the drawings. Like elements are denoted by like reference numerals throughout the various figures, and will not be described repeatedly.

### 1. First Embodiment

1.1. Configuration

1.1.1. System Configuration

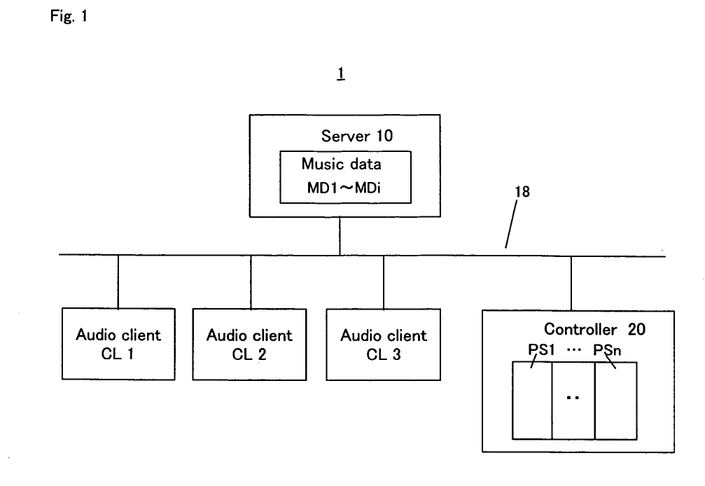

Referring to FIG. 1, a network AV system 1 includes a server 10, a controller 20 and a plurality of audio clients CL (CL1 to CL3). The controller 20 and the audio clients CL1 to CL3 are connected to the server 10 via a LAN cable 18.

The server 10 stores a plurality of items of music data MD1 to MDi (i is a natural number). The controller 20 stores program schedules PS1 to PSn each associated with one or more of the audio clients CL1 to CL3, and instructs an audio client CL (one or more of the audio clients CL1 to CL3) to reproduce music data MD according to the program schedules PS1 to PSn. In response to the instruction, the audio client CL requests the music data MD (one of the music data MD1 to MDi). In response to the request, the server 10 sends back the music data MD to the audio client CL. The client CL reproduces the music piece based on the music data MD from the server 10. While FIG. 1 shows one server 10, one controller 20 and three audio clients CL1 to CL3, the number of each of these elements is not limited to this. Moreover, while the content to be requested and distributed is music data MD in the present embodiment, it may alternatively be video data or AV data.

1.1.2. Server

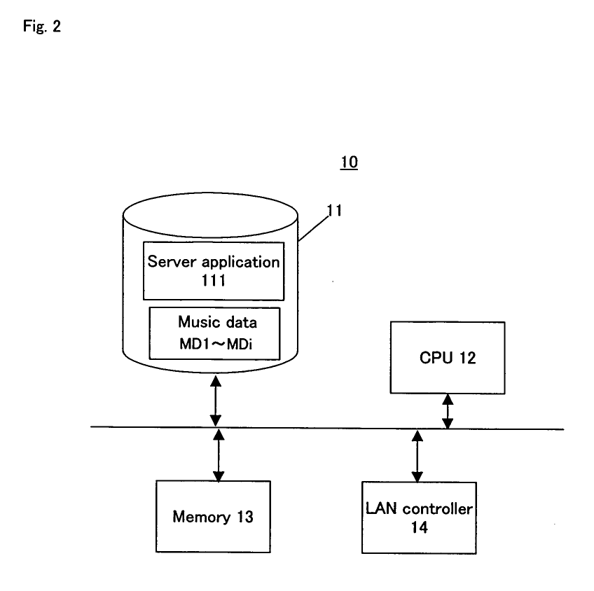

Referring to FIG. 2, the server 10 includes a hard disk 11, a CPU 12, a memory 13 and a LAN controller 14, with a server application program 111 being installed on the hard disk 11. These components are connected to one another via a bus. The server application program 111 can be installed on a general-purpose computer so that the CPU 12 operates based on the program loaded on the memory 13. Then, the computer functions as the server 10. The hard disk 11 stores a plurality of items of music data MD1 to MDi to be distributed to the audio clients CL.

1.1.3. Controller

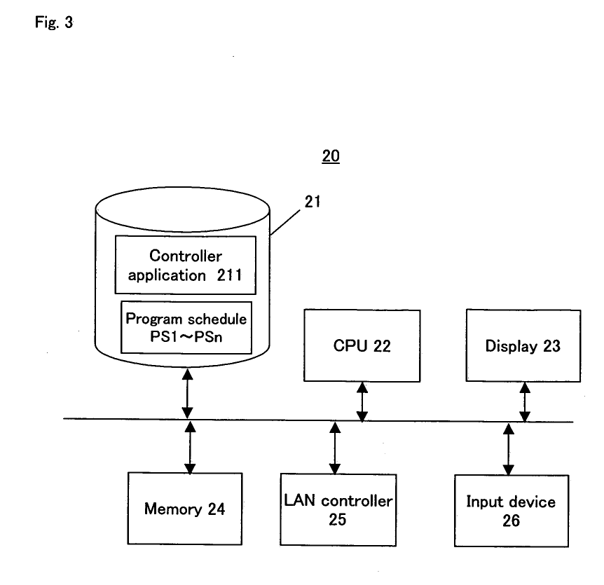

Referring to FIG. 3, the controller 20 includes a hard disk 21, a CPU 22, a display 23 such as a CRT or an LCD, a memory 24, a LAN controller 25 and an input device 26 such as a mouse or a keyboard, with a controller application program 211 being installed on the controller 20. These components are connected to one another via a bus. The controller application program 211 can be installed on a general-purpose computer so that the CPU 22 operates based on the program loaded on the memory 24. Then, the computer functions as the controller 20.

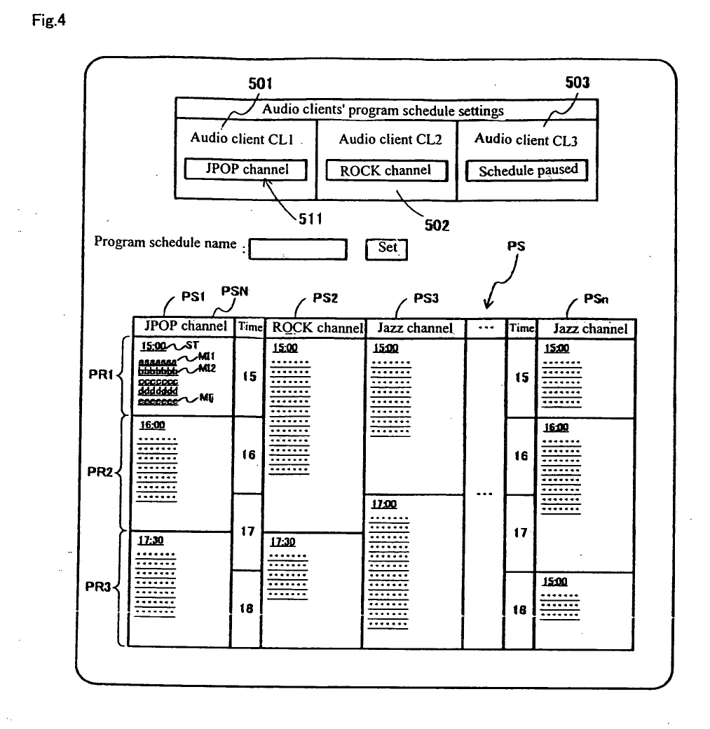

The hard disk 21 stores a plurality of program schedules PS1 to PSn (n is a natural number). Each of the program schedules PS1 to PSn is a schedule of programs to be reproduced in various time slots in a day (0:00-24:00). Various pieces of information included in the program schedules PS1 to PSn are displayed on the display 23 as shown in FIG. 4. Each program schedule PS displayed on the display 23 includes a plurality of programs PR each associated with a predetermined reproduction time slot. For example, the program schedule PS1, whose program schedule name PSN is “JPOP channel”, includes a program PR1 to be reproduced from 15:00 to 16:00, a program PR2 from 16:00 17:30, and a program PR3 from 17:30 to 19:00. Each program PR includes a reproduction start time ST, and items of music information MI1 to MIj (j is a natural number) each being information about a music piece to be reproduced during the program.

A program schedule PSn stored in the hard disk 21 shown in FIG. 3 includes program schedule information PSIn associated therewith. Table 1 below shows an example of the program schedule information PSI1 included in the program schedule PS1.

TABLE 1
Program Schedule PS1
Program Schedule Information PSI1

| | |
|---|---|
| Program Schedule Name PSN | JPOP channel |
| Playlist ID | ID of playlist in which program is |
| | registered |
| Current Program Number | program number 1 |
| Program List | program list PL1 |

Referring to Table 1, the “Program Schedule Name” field stores the program schedule name PSN of the program schedule PS. In the example of Table 1, the value of this field is the program schedule name PSN of the program schedule PS1, i.e., “JPOP channel”. The “Playlist ID” field stores the identifier of a playlist registered in the server 10. A playlist is a temporary list of music pieces, and is stored in the memory 13 of the server 10. The “Current Program Number” field stores the program number of the program that is currently subject to the program instruction process. The program instruction process will be described later. The “Program List” field stores a program list PL included in the program schedule PS. In Table 1, the value of this field is “program list PL1”. Table 2 below shows the program list PL1.

TABLE 2
Program List PL1

| | |
|---|---|
| Program Number 1 | program information PI1 |
| Program Number 2 | program information PI2 |
| Program Number 3 | program information PI3 |
| Program Number 4 | program information PI4 |
| . | . |
| . | . |
| . | . |
| Program Number k | program information PIk |

The program list PL1 includes a plurality of items of program information PI1 to PIk each associated with a program number ranging from 1 to k (k is a natural number). The program information PIk is a piece of information about the program PRk. For example, referring also to FIG. 4, the program information PI1 and PI2 are pieces of information about the programs PR1 and PR2, respectively. Table 3 below shows the program information PI1.

TABLE 3
Program Information PI1

| | | |
|---|---|---|
| Reproduction | Reproduction Start Time ST | 15:00 |
| Time Slot | Reproduction Finish Time FT | 16:00 |

| | |
|---|---|
| Program Status | not started |
| Content Information | music list ML1 |

The program information PI1 includes three fields, i.e., “Reproduction Time Slot”, “Program Status” and “Content Information”. The “Reproduction Time Slot” field stores the reproduction start time ST and the reproduction finish time FT of the program PR1. The “Program Status” field stores the reproduction status of the program. For example, the value of this field is “not started” if the reproduction of the program PR1 has not yet started, “program has started” if the program PR1 is being reproduced, and “music list changed” if a music list ML, which will be described later, has been changed.

The “Content Information” field stores content information representing a list of content items to be reproduced in the program PR1. Since the content to be requested and distributed is music data MD in the present embodiment, the content information is referred to as a “music list ML”. In the example of Table 3, the value of this field is “music list ML1” representing a list of music pieces to be reproduced in the program PR1. Table 4 below shows the music list ML1.

TABLE 4
Music List ML1

| | |
|---|---|
| Music Number 1 | music information MI1 |
| Music Number 2 | music information MI2 |
| Music Number 3 | music information MI3 |
| Music Number 4 | music information MI4 |
| . | . |
| . | . |
| . | . |
| Music Number j | music information MIj |

The music list ML1 includes music information MI1 to MIj each associated with a music number ranging from 1 to j (j is a natural number). The music information MIj is a piece of information for identifying the music data MDj stored in the server 10. For example, the music information MIj represents the music ID (the identification number of the music piece), the title, the artist name, etc. During the reproduction of a program PR, music pieces are reproduced in the order of their music numbers.

The hard disk 21 further stores a plurality of items of client data CD1 to CD3. The client data CD1 to CD3 represent information about the audio clients CL1 to CL3, respectively. The controller 20 monitors the audio clients CL1 to CL3 based on the client data CD1 to CD3. Table 5 below shows the client data CD1.

TABLE 5
Client Data CD1

| | |
|---|---|
| Program Schedule | program schedule PS1 |
| Reproduction Status | stopped |

The client data CD1 includes two fields, i.e., “Program Schedule” and “Reproduction Status”. The “Program Schedule” field stores a program schedule associated with the client CL1. In the example of Table 5, the value of this field is “program schedule PS1”. The “Reproduction Status” field stores the reproduction status of the client CL1. Specifically, the value of this field is “reproducing” or “stopped”. Referring to FIG. 4, the program schedule names in the “Program Schedule” field of the client data CD1 to CD3 are displayed in client data areas 501 to 503, respectively. For example, “JPOP channel” is displayed in a program schedule area 511 of the client data area 501.

1.1.4. Audio Client

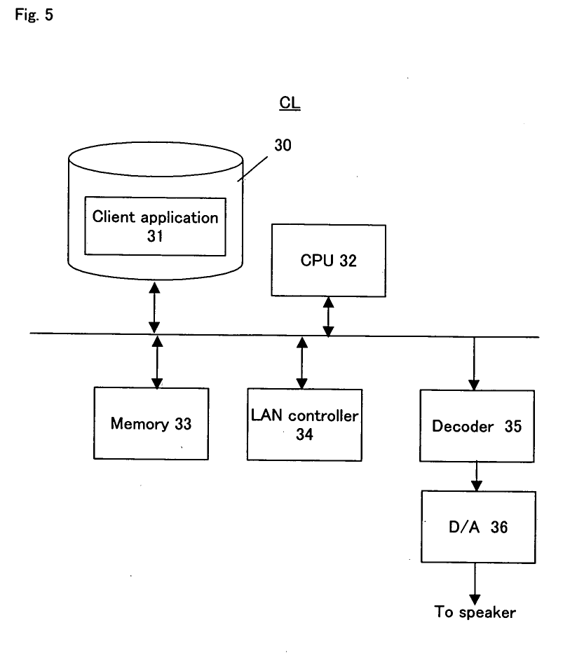

Referring to FIG. 5, the audio client CL includes a hard disk 30, a CPU 32, a memory 33, a LAN controller 34, a decoder 35 and a D/A converter 36.

In response to an instruction from the controller 20, the audio client CL reproduces a music piece based on the music data MD distributed from the server 10. A client application program 31 installed on the hard disk 30 instructs the audio client CL to execute various steps, which will be described later, thereby giving the decoder 35 the music data MD distributed from the server 10. The decoder 35 decodes the music data MD and gives a decoded signal to the D/A converter 36. The D/A converter 36 converts the digital audio signal from the decoder 35 to an analog audio signal and outputs it to a speaker (not shown).

1.2. Operation

1.2.1. Connection Process

In the network AV system 1, the audio client CL first establishes a connection to the server 10. While the following description is directed to the connection process by the audio client CL to the server 10, it similarly applies to the connection process by the controller 20 to the server 10.

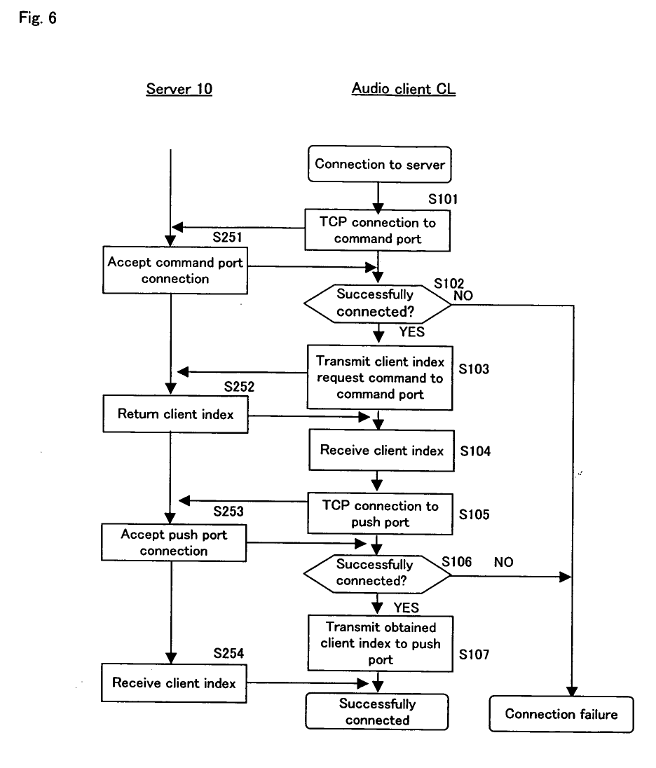

Referring to FIG. 6, the audio client CL creates a TCP (Transmission Control Protocol) socket with the IP (Internet Protocol) address and the command port address of the server 10, and sends a connection request to the server 10 via the socket (S101). The command port is a port for receiving a command sent from the audio client CL to the server 10 and for transmitting a response sent from the server 10 to the audio client CL. The server 10 accepts a connection to the command port (S251), and the process proceeds to step S103 if the connection is successfully established (S102). In this way, the audio client CL establishes a connection to the command port of the server 10.

Then, the audio client CL transmits a client index request command to the command port (S103). In response to the client index request command, the server 10 returns a client index to the audio client CL via the command port (S252), and the audio client CL receives the client index (S104). The client index request command is a command by which the audio client CL requests the server 10 for a client index. A client index is an identifier (ID) assigned by the server 10 to an audio client CL.

Then, the audio client CL creates a TCP socket with the IP address and the push port address of the server 10, and sends a connection request to the server 10 via the socket (S105). The push port is a port for transmitting a request from the server 10 to the audio client CL. The server 10 accepts a connection to the push port (S253), and the process proceeds to step S107 if the connection is successfully established (S106). In this way, the audio client CL establishes a connection to the push port of the server 10. At this point, the server 10 has not yet identified the device connected to the push port. Therefore, the audio client CL transmits the client index, which has been received in step S104, to the push port of the server 10 (S107). The server 10 receives the client index (S254), thus identifying the device connected to the push port.

1.2.2. Operation Of Controller

The controller 20 performs a program schedule updating process, a program schedule selection process and a program instruction process. In the program schedule updating process, the controller 20 creates a music list ML and program information PI, and registers them in the program schedule PS. Note that “creating” as used herein also includes “changing”, i.e., creating new program information PI and replacing old program information PI with the new program information PI. In the program schedule selection process, the controller 20 associates an intended program schedule PS with an intended audio client CL. In the program instruction process, the controller 20 instructs the audio client CL to start or stop the reproduction of a program PR according to the program schedule PS. These processes will now be described in detail.

1.2.2.1. Program Schedule Updating Process

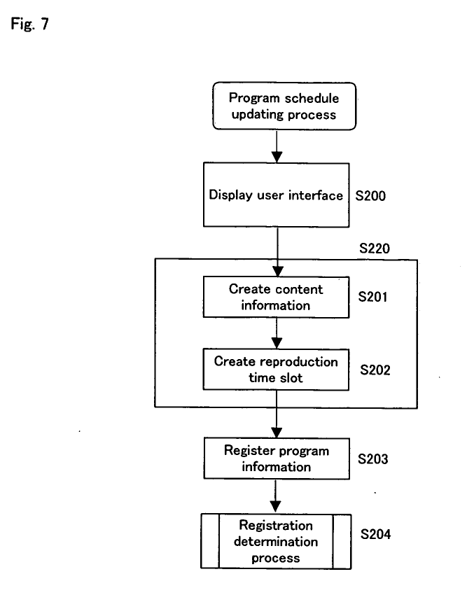

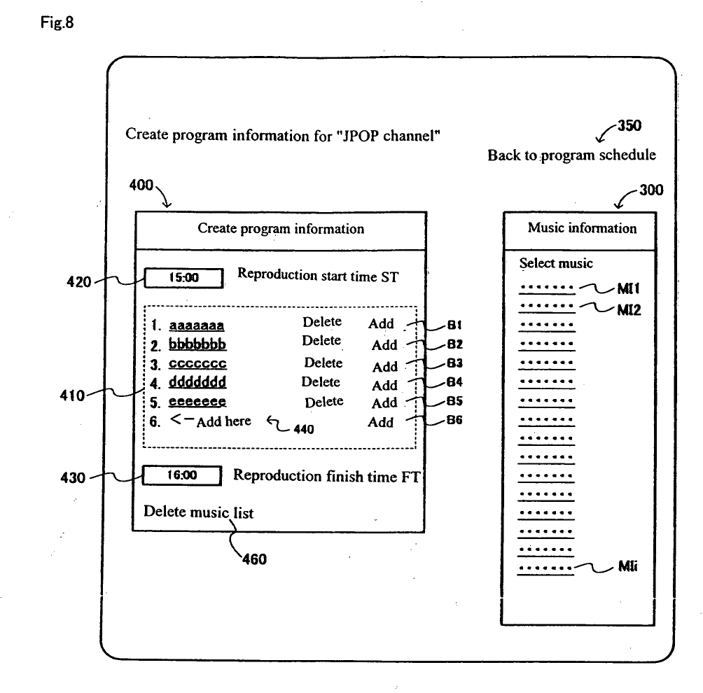

Referring to FIG. 4, FIG. 7 and FIG. 8, the controller 20 displays the user interface as shown in FIG. 4 on the display 23 (S200). After the user interface is displayed, the controller 20 creates program information PI based on operations by the user using the input device 26 (S220). When creating program information PI1 of a program PR1 in the program schedule PS1, the program schedule name PSN of the program schedule PS1 (“JPOP channel”) in the user interface is selected based on a user operation. Then, the controller 20 displays a program information creating UI (User Interface) as shown in FIG. 8 on the display 23.

The program information creating UI includes a music information area 300 and a program information creating area 400. The music information area 300 shows music information MI1 to MIi (e.g., titles) of music data MD1 to MDi stored in the server 10. The music information MI1 to MIi are displayed in the music information area 300 as follows. For example, when a program schedule name PSN=“JPOP channel” is selected, the controller 20 sends a music information request command to the server 10, and the server 10 sends back the music information MI1 to MIi to the controller 20 in response to the music information request command. The music information MI1 to MIi are stored in the memory 24 and displayed in the music information area 300. The music information MI1 to MIi may be stored in advance in the hard disk 21 of the controller 20.

The program information creating area 400 includes a music list creating area 410, an ST input area 420 and an FT input area 430. The music list creating area 410 shows the music number and the music information MI of each music piece.

Based on a user operation, the controller 20 creates the music list ML1 (content information) (S201). The controller 20 first determines a music number. In order to set intended music information MI for the music number 6, an “Add” button B6 is selected from among a plurality of “Add” buttons B1 to B6 displayed in the music list creating area 410. Then, an “Add here” cursor 440 is displayed at the position of the music number 6.

Then, based on a user operation, the controller 20 selects intended music information MI from the music information area 300. The selected music information MI is set at the position of the music number 6 in the music list creating area 410. Similarly, in order to set new music information MI for the music number 2, the “Add” button B2 can be selected. Then, the “Add here” cursor 440 is displayed at the position of the music number 2, while the music piece entitled “bbbbbbb” and subsequent music pieces are shifted down to positions starting from the music number 3.

Through the operation described above, the controller 20 can create the music list ML1 including a plurality of selected music data MD from among music data MD1 to MDi based on user operations. Since music pieces are reproduced in the order of their music numbers as will be described later, the order in which music pieces are reproduced can be freely determined by the user.

After the music list ML1 (content information) is created, the controller 20 creates a reproduction time slot (S202). Based on a user operation, the controller 20 sets a reproduction start time ST=“15:00” in the ST input area 420 and a reproduction finish time FT=“16:00” in the FT input area 430.

Then, when the user selects an OK button 350, the program information PI1 created in step S220 is registered in the program schedule PS1 (S203). Specifically, the program information PI1 is registered in the program list PL1 in the program schedule PS1. Through a similar operation, the program information PI1 can also be changed. The user can select a delete button 460 in the program information creating area 400 to delete the program information PI1 from the program schedule PS1.

Thus, the program information PI (program PR) in the program schedule PS can be freely created by the controller 20 based on user operations. Moreover, the created program information PI can be registered in an intended program schedule PS.

After the program information PI1 is registered in the program schedule PS1, the controller 20 performs a registration determination process (S204). In the registration determination process, the controller 20 rearranges items of program information PI in the program schedule PS1 based on the created program information PI. Moreover, the controller 20 sets a program status of the created program information PI1. The program status is utilized in the program instruction process to be described later.

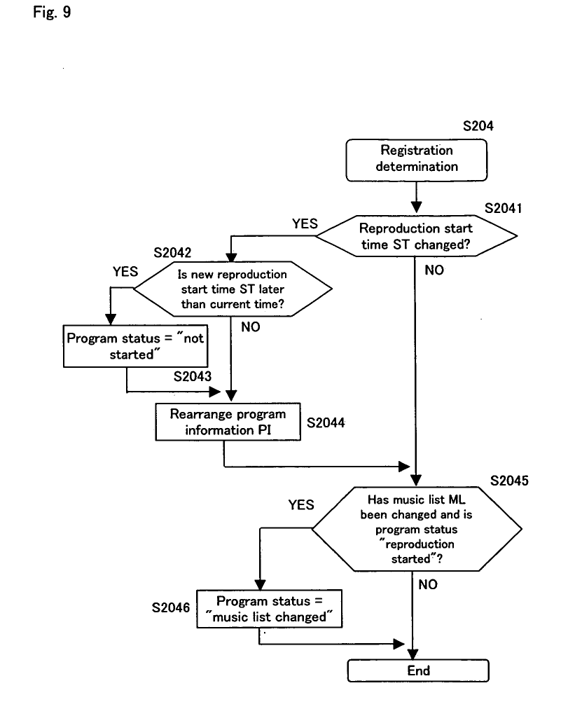

Referring to FIG. 9, in the registration determination process (S204), the controller 20 first determines whether or not the reproduction start time ST of the created program information PI1 has been changed (S2041). The controller 20 determines that the reproduction start time ST has been changed if the program information PI1 is newly created or if the program information PI1 is newly created to replace old program information PI1 resulting in a change in the reproduction start time ST. Then, the controller 20 determines whether or not the reproduction start time ST is later than the current time (S2042). If the reproduction start time ST is later than the current time, “not started” is set in the “Program Status” field of the created program information PI1 (S2043). Then, the controller 20 rearranges the items of program information PI included in the program schedule PS1 (including the created program information PI1) in the order of their reproduction start times ST (S2044). Since programs are reproduced in the order of their program numbers, the items of program information PI are rearranged in the order of their reproduction start times ST.

After step S2044, or after it is determined in step S2041 that the reproduction start time ST has not been changed (e.g., where only the music list ML1 of the program information PI1 is changed), the controller 20 determines if the music list ML in the created program information PI1 has been changed and if the program status in the created program information PI1 is “reproduction started” (S2045). In other words, the controller 20 determines whether or not the music list ML of the program information PI being reproduced has been changed. If the content information has been changed and the program status is “reproduction started”, i.e., if the music list ML1 of the program information PI1 being reproduced has been changed, the controller 20 changes the program status from “reproduction started” to “music list changed”, and exits the process. Even if the music list ML is changed during the reproduction, the program status can be changed to “music list changed” and the reproduction can be continued based on the changed music list ML. The details of this will be described later.

1.2.2.2. Program Schedule Selection Process

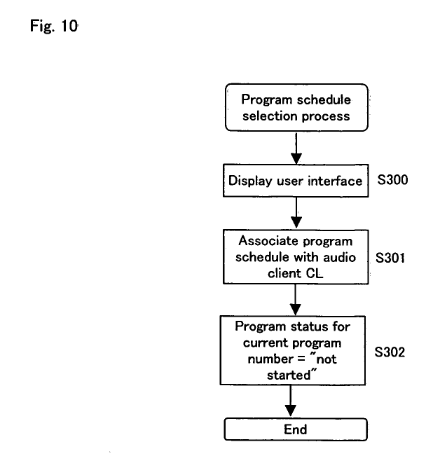

In the program schedule selection process, the controller 20 associates an intended program schedule PS with an intended audio client CL. Referring to FIG. 4 and FIG. 10, the controller 20 displays the user interface as shown in FIG. 4 on the display 23 (S300). The user interface includes the client data areas 501 to 503. In order to associate the program schedule PS1 with the audio client CL1, the controller 20 inputs the program schedule name PSN of the program schedule PS1 (“JPOP channel”) in the area 511 of the client data area 501 associated with the client data CD1 based on a user operation. Then, the controller 20 sets “program schedule PS1” (the program schedule whose program schedule name is “JPOP channel”) in the “Program Schedule” field of the client data CD1 (S301). Thus, the program schedule PS1 is associated with the audio client CL1. Then, the controller 20 confirms that the current program number of the program schedule information PSI1 of the registered program schedule PS1 is “program number 1”, and sets “not started” in the “Program Status” field of the program information PI1 associated with “program number 1” (S302). Thus, the audio client CL, which has been newly associated with the program schedule PS in step S301, can immediately start reproducing music pieces according to the program schedule PS. The details of this will be described later.

1.2.2.3. Program Instruction Process

The controller 20 periodically performs the program instruction process. In the program instruction process, the controller 20 instructs the audio client CL to start or stop the reproduction of music data MD according to the program schedule PS.

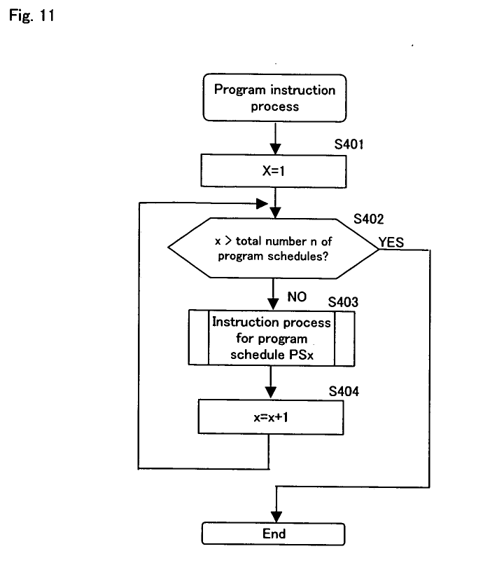

Referring to FIG. 11, the controller 20 first sets a counter x for the program schedules PS to 1 (S401). Then, it is determined whether or not the counter x=1 is greater than the total number n of the program schedules PS (S402). The counter x=1 being less than the total number n of the program schedules PS means that the hard disk 21 contains a program schedule PSx (i.e., the program schedule PS1). The controller 20 performs an instruction process according to the program schedule PS1 (S403). In the instruction process, the controller 20 gives an instruction to start or stop the reproduction to all the audio clients CL associated with the program schedule PS1.

After the instruction process in step S403, the controller 20 increments the counter x (S404) and returns to step S402. Thus, the controller 20 performs the instruction process (S403) for all of the program schedules PS1 to PSn. If the counter x exceeds the total number n of the program schedules PS (i.e., if the instruction process has been performed for all of the program schedules PS1 to PSn), the controller 20 exits the program instruction process.

The instruction process in step S403 for a case where the counter x is 1 (i.e., the instruction process for the program schedule PS1) will now be described.

Instruction Process Immediately After Reproduction Start Time

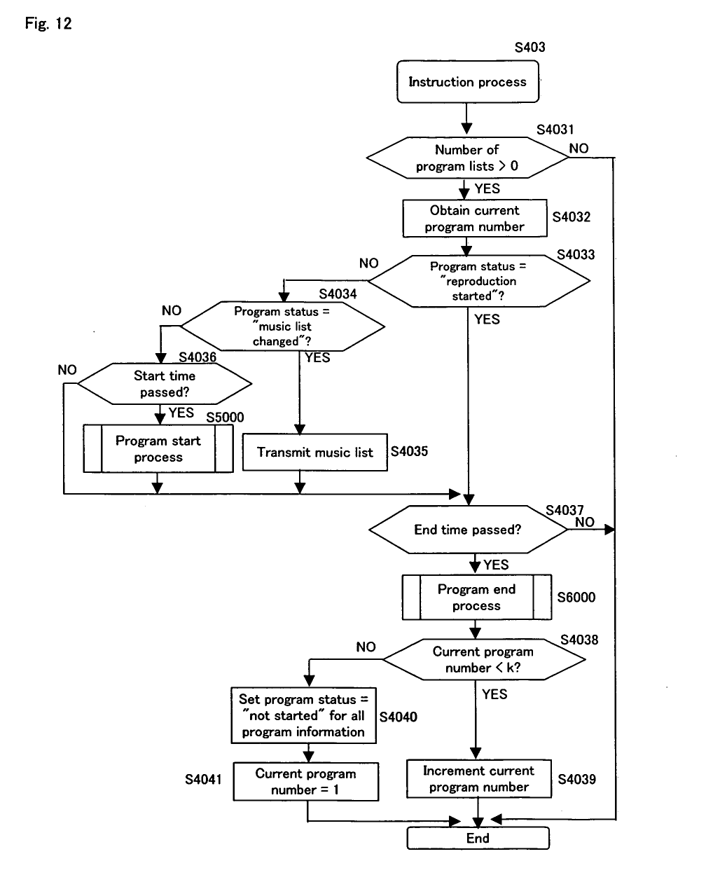

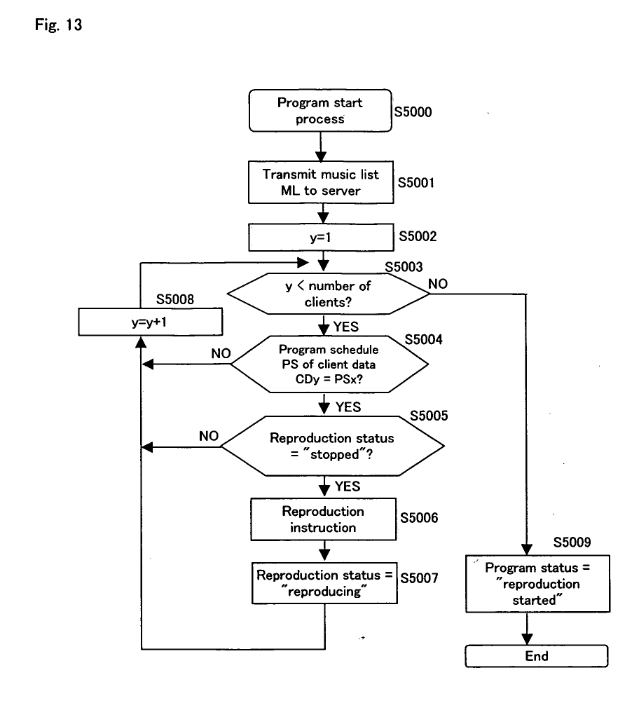

Assume that the current time is 15:00. Referring to FIG. 12 and FIG. 13, the controller 20 determines whether or not the program list PL1 of the program schedule PS1 contains any program information PI (S4031). If the program list PL1 does not contain any program information PI, meaning that there is no music piece to reproduce, the controller 20 exits the instruction process.

Since the program list PL1 includes a plurality of items of program information PI1 to PIk, the process proceeds to step S4032. In step S4032, the controller 20 obtains “program number 1”, being the current program number, from the program schedule information PSI1. The current program number is the program number of program information PI that is currently subject to the instruction process at the current time. The controller 20 refers to the program list PL1 to identify program information PI1 as the program information associated with the program number 1. The controller 20 checks the program status of the identified program information PI1 (S4033 and S4034).

Immediately after 15:00, the program status of the program information PI1 is still “not started”. In other words, the controller 20 determines that the status is not “reproduction started” in step S4033 and that it is not “music list changed” in step S4034. Then, the controller 20 determines that the current time (immediately after 15:00) is past the reproduction start time ST (15:00) set in the program information PI1 (S4036). Then, the controller 20 performs a program start process to instruct the audio client CL1 associated with the program schedule information PSI1 to reproduce a music piece according to the program information PI1 (S5000). After the program reproduction process, the controller 20 determines that the reproduction finish time FT (16:00) of the program information PI1 is not past the current time (S4037), and thus exits the instruction process.

The program start process in step S5000 will now be described. The controller 20 transmits to the server 10 the music list ML1 that is set in the “Content Information” field of the program information PI1 (S5001). At this point, the controller 20 also transmits to the server 10 the playlist ID in the program schedule information PSI1. The server 10 registers the received music list ML1 in the playlist that is specified by the received playlist ID.

After the music list ML1 is transmitted, a counter y for the audio clients CL is set to 1 (S5002). Then, it is determined whether or not the total number of audio clients CL (3 in the present embodiment) is greater than the counter y (S5003). The controller 20 obtains the total number of audio clients CL based on the total number of items of client data CD.

The total number of audio clients CL is greater than the counter y=1. Therefore, the controller 20 refers to the client data CDy (i.e., the client data CD1). The controller 20 determines whether or not the “Program Schedule” field of the client data CD1 indicates the program schedule PSx, i.e., the program schedule PS1 (counter x=1) (S5004). Since the “Program Schedule” field of the client data CD1 indicates the program schedule PS1, the controller 20 then determines whether or not the reproduction status of the client data CD1 is “stopped” (S5005). If the reproduction status is “stopped”, no music piece is being reproduced. Then, the controller 20 transmits a reproduction instruction to the audio client CL1 (S5006). The reproduction instruction is transmitted to the audio client CL1 via the server 10. Receiving the reproduction instruction, the audio client CL1 performs a music reproduction process to successively reproduce music pieces. The music reproduction process will be described later.

After transmitting the reproduction instruction, the reproduction status of the client data CD1 is updated to “reproducing” (S5007). Thus, the controller 20 can know that the audio client CL1 is reproducing a music piece. Then, the controller 20 increments the counter y (S5008) and returns to step S5003. Thus, the controller 20 checks the reproduction status of, and transmits the reproduction instruction to, all of the audio clients CL that are associated with the program schedule PS1.

If it is determined in step S5003 that the counter y is greater than the total number of audio clients CL, i.e., if all of the audio clients CL1 to CL3 have been checked as to whether they are associated with the program schedule PS1, the controller 20 updates the program status of the program information PI1 from “not started” to “reproduction started” (S5009). Thus, the program status is updated to “reproduction started” after the reproduction instruction is transmitted to all of the audio clients CL that are associated with the program schedule PS1.

In the instruction process (S403) after performing the program start process immediately after 15:00 and until the reproduction finish time FT (16:00), the controller 20 determines that the program status is “reproduction started” (S4033) and that the reproduction finish time FT (16:00) of the program information PI1 has not been reached (S4037). Therefore, the controller 20 simply exits the process.

If the audio client CL2 is newly associated with the program schedule PS1 in the program schedule selection process while the audio client CL1 is reproducing a music piece based on the music list ML1, the program status of the program information PI1 is updated from “reproduction started” to “not started” in step S302 of the program schedule selection process (FIG. 10). Thus, the program status of the program information PI1 will be “not started” even though the audio client CL1 is reproducing a music piece based on the program information PI1. Therefore, the program start process (S5000) is performed in the instruction process. The controller 20 determines that the reproduction status of the audio client CL1 is “reproducing” in step S5005. Therefore, the controller 20 does not transmit a reproduction instruction to the audio client CL1. Since the reproduction status of the newly-associated audio client CL2 is “stopped”, the controller 20 transmits a reproduction instruction to the audio client CL2. As a result, even if the audio client CL2 is newly associated with the program schedule PS1 including the program information PI1 being reproduced, the audio client CL2 can start reproducing a music piece based on the program information PI1 immediately after it is associated with the program schedule PS1.

Instruction Process Immediately After Reproduction Finish Time

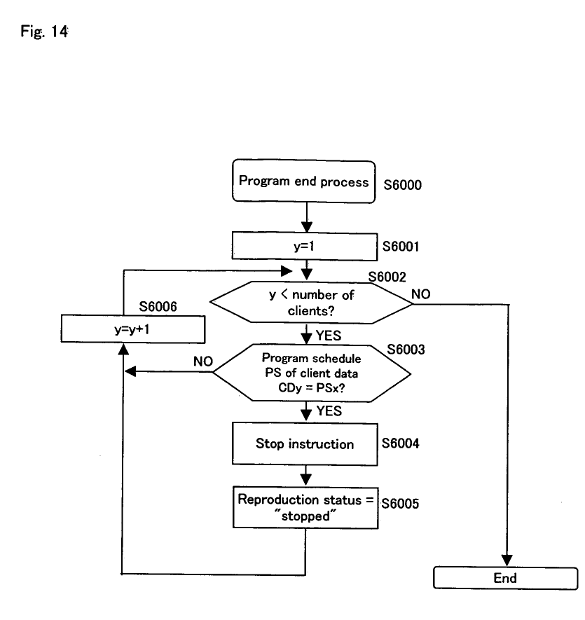

The instruction process in step S403 immediately after 16:00 will now be described. Referring to FIG. 12 and FIG. 14, the controller 20 determines in step S4033 that the program status of the program information PI1 is “reproduction started”. Then, in step S4037, the controller 20 determines that the reproduction finish time FT=16:00 of the program information P1 has been passed. Then, the controller 20 performs the program end process to stop the reproduction of music pieces based on the program information PI1 (S6000). Then, the controller 20 determines whether or not the current program number of the program schedule information PSI1 is smaller than the program number k of the last program registered in the program list PL1 (S4038). Since the program number 1 of the program schedule information PSI1 is smaller than k, the controller 20 increments the current program number to 2 (S4039). Thus, after the reproduction of the program information PI1 ends, the program information P12 (program PR2) is set to be subject to the program instruction process.

If the current program number is equal to k in step S4038, meaning that the reproduction of the last program information PIk of the program list PL1 has been completed, the controller 20 updates the program status to “not started” for all of the program information PI in the program list PL1 (S4040), updates the current program number to “program number 1” (S4041), and exits the instruction process. The completion of the reproduction of the program information PIk means that all of the programs PR in the program schedule PS1 have been reproduced. In other words, it means that the program reproduction schedule of the program schedule PS1 for the day has been completed. As the program status is set to “not started” for all of the program information PI1 to PIk, the programs will be reproduced again the next day starting from the program information PI1 whose program number is 1.

The program end process in step S6000 will now be described. In the program end process, the counter y is first initialized to 1 (S6001). Then, it is determined whether or not the total number of audio clients CL is greater than the counter y (S6002). If so, it is then determined whether or not the program schedule of the client data CD1 is the program schedule PS1 (counter x=1) (S6003). Since the program schedule of the client data CD1 is “program schedule PS1”, the controller 20 transmits a stop instruction to the audio client CL1 (S6004). Receiving the stop instruction, the audio client CL1 stops the reproduction of a music piece based on the program information P1. After transmitting the stop instruction, the controller 20 updates the reproduction status of the client data CD1 from “reproducing” to “stopped”. Then, the controller 20 increments the counter y (S6006) and returns to step S6002. Thus, the program end process is performed for all of the audio clients CL1 to CL3.

Instruction Process When Music List is Changed During Reproduction by Audio Client

From 15:00 to 16:00, the audio client CL1 reproduces music pieces in the music list ML1 of the program information P11 in the order of their music numbers. If the controller 20 changes the music list from ML1 to ML10 in the program schedule updating process (S201 in FIG. 7) while the audio client CL1 is reproducing a music piece, the program status of the program information PI1 is updated to “music list changed” (step S2046 in FIG. 9) in the registration determination process (S204).

In the instruction process in step S403, it is determined in step S4034 that the program status of the program information PI1 is “music list changed”. Then, the controller 20 transmits the music list ML10 to the server 10 (S4035). The server 10 registers the received music list ML10 in the playlist in which the music list ML1 has been registered. At this point, the music list ML1 is deleted from the playlist. In other words, the music list registered in the playlist is switched from the music list ML1 to the music list ML10.

Although the audio client CL1 is already reproducing a music piece, the audio client CL1 obtains the music list ML10 newly registered in the playlist and continues the reproduction process. Thus, even if a music list ML is switched to another while it is being reproduced, the reproduction process can be continued based on the new music list ML. The music reproduction process by the audio client CL1 where the music list ML is switched to another will be described later.

1.2.3. Music Reproduction Process by Audio Client

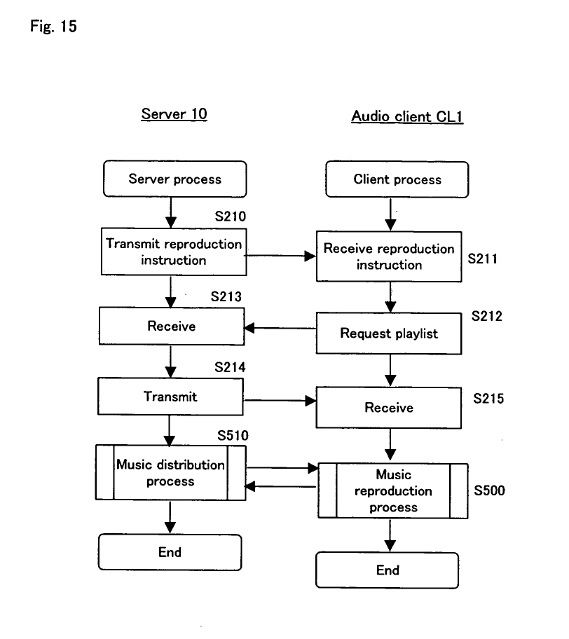

Referring to FIG. 15, the server 10 relays the reproduction instruction from the controller 20 (S210), and the audio client CL1 receives the reproduction instruction (S211). The reproduction instruction includes a playlist ID. After receiving the reproduction instruction, the audio client CL1 requests the server 10 for a playlist (S212). In this step, the playlist ID received in step S211 is transmitted to the server 10.

The server 10 receives the request from the audio client CL1 (S213), and transmits to the audio client CL1 the music list ML1 registered in the playlist ID (S214).

The audio client CL1 receives the music list ML1 (S215), and performs a music reproduction process of reproducing the music data MD1 whose music number is 1 based on the music list ML1 (S500). In this process, in response to a request from the audio client CL1, the server 10 performs a music piece distribution process of distributing music data MD1 to MDj to the audio client CL1 (S510). The music reproduction process and the music piece distribution process will now be described in detail.

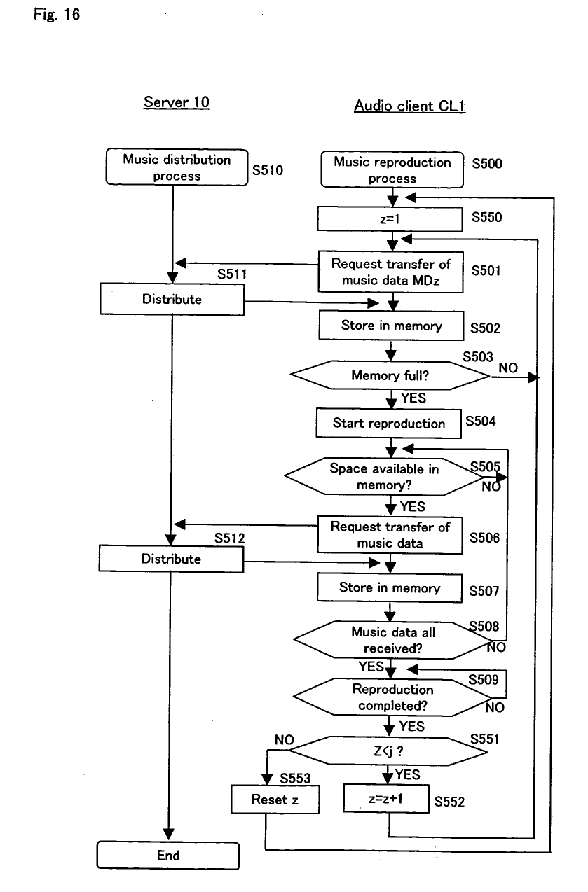

Referring to FIG. 16, the audio client CL1 sets a counter z for the music numbers to 1 (S550). The audio client CL1 transmits a music data transfer request command as shown in Table 6 below via the command port so as to request the music data MD1 associated with the music number z=1 (S501).

TABLE 6
Music Data Transfer Request Command

| | |
|---|---|
| Parameters | start address |
| | data length |

The music data transfer request command contains the start address and a data length of the music data MD 1 to be transmitted.

In response to the request for the music data MD1, the server 10 sends back the audio client CL1 a portion of the music data MD1 of the specified data length starting from the specified start address (S511). The audio client CL1 stores in the memory 33 the received portion of the music data MD1. The memory 33 includes a plurality of buffers each having the size of the specified data length. With a music data transfer request command, the audio client CL1 obtains portions of music data each having the size of one buffer (=data length) starting from the beginning of the music piece, and stores them in the buffers (S502). Each time the audio client CL1 receives a portion of music data, the audio client CL1 determines whether or not all of the buffers of the memory 33 have been filled with the music data (S303), and keeps receiving the music data until the buffers are all full.

When the buffers are all filled with the music data after repeating steps S501 to S503, the audio client CL1 starts reproducing the music piece (S504). Specifically, the audio client CL1 starts transferring the buffered portions of the music data to the decoder 35, starting from the first buffer in the memory 33. As the music data is transferred and reproduced, there will be a one-buffer space available in the memory 33. When there is a space in the memory 33 (S505), the audio client CL1 again transmits the music data request to the server 10 (S506), in response to which the server 10 sends back a requested portion of the music data (S512). The audio client CL1 stores the received portion of the music data in a buffer available in the memory 33 (S507). Then, the audio client CL1 determines whether or not the whole music data MD1 has been received (S508). If the whole music data MD1 has not been received, i.e., if the server 10 has not completely transmitted the whole music data MD1 to the audio client CL1, the audio client CL1 and the server 10 repeat steps S506, S512 and S507 each time a space is made available in the memory 33 as the music piece is reproduced. While the reproduction process is started after all buffers are filled with music data in the above description, the reproduction process may be started before all buffers are filled up.

If it is determined that the audio client CL1 has received the whole music data MD1 from the server 10 (S508), the audio client CL1 continues the reproduction operation until the whole music data MD1 is reproduced (S509).

After the reproduction of the music data MD1 is completed, the audio client CL1 determines whether or not the counter z is less than the music number j (S551). If the counter z is less than the music number j, the audio client CL1 increments the counter z (S552) and returns to step S501. Thus, the audio client CL1 successively reproduces music pieces in the music list ML1 in the order of their music numbers.

If it is determined in step S551 that the counter z is equal to the music number j, the counter z is reset (S553) and the process returns to step S550. Thus, after all the music pieces in the music list ML1 are reproduced, the reproduction operation is continued by resetting the music number counter z back to 1. The audio client CL1 continues the music reproduction process until a stop instruction is received from the controller 20. When a stop instruction is received from the controller 20, the audio client CL1 stops the reproduction process.

While the audio client CL1 reproduces music pieces in the order of their music numbers in the example of FIG. 16, the controller 20 may instead control the reproduction operation at the audio client CL1. For example, after the audio client CL1 completes the reproduction of music data MDz, the audio client CL1 may notify the controller 20 of the completed status. Then, the controller 20, notified of the completed status, transmits to the audio client CL1 a reproduction command for reproducing music data MDz+1. Receiving the reproduction command, the audio client CL1 reproduces the music data MDz+1. Thus, the controller 20 can control the successive reproduction process at the audio client CL1.

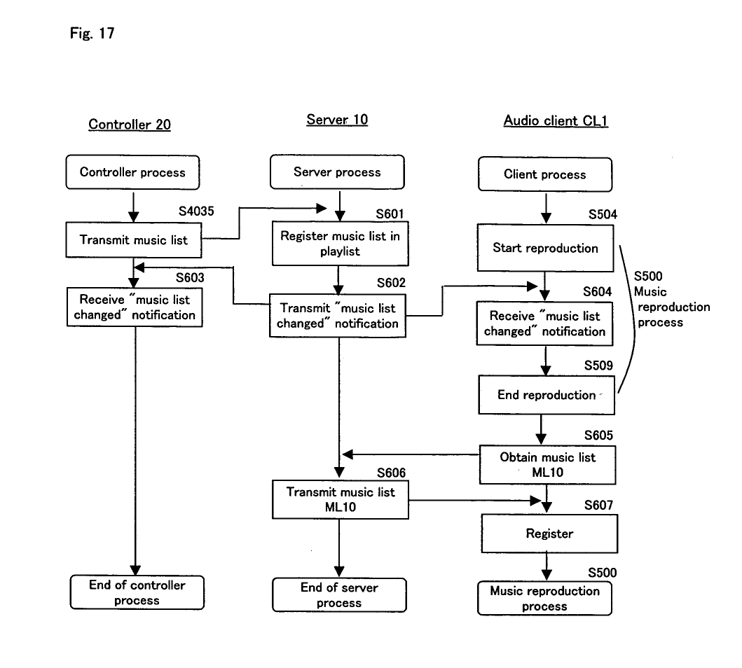

Music Reproduction Process When Music List is Changed During Reproduction Process

Where the music list is switched from ML1 to ML10 while the audio client CL1 is performing the music reproduction process (S500) based on the music list ML1, the music reproduction process is performed as follows. Referring to FIG. 17, the controller 20 transmits the new music list ML10 to the server 10 (S4035) in the instruction process (S403) of the program instruction process. The server 10 registers the received music list ML10 in the playlist in which the music list ML1 has been registered (S601). At this point, the music list ML1 is deleted from the playlist. Then, the server 10 broadcasts a “music list changed” notification. The audio client CL1 receives the “music list changed” notification while it is performing the music reproduction process (S604). After the audio client CL1 completes the reproduction of the music data MDz, which was being reproduced when the “music list changed” notification was received (S509), the audio client CL1 requests the server 10 for the music list ML10 (S605). In response to the request, the server 10 sends back the music list ML10 (S606), and the audio client CL1 stores the music list ML10 in the memory 33 (S607). Then, the music reproduction process (S500) is performed based on the music list ML10.

Thus, if a “music list changed” notification is received while music data MDz is being reproduced, the audio client CL1 obtains the new music list ML10 after the completion of the reproduction process for the music data MDz. Thus, it is possible to prevent the reproduction of the music data MDz from being discontinued before it is finished.

The network AV system 1 of the present invention can be used as a broadcasting station. For example, a plurality of audio clients CL can be provided on different floors of a department store. Then, the content items stored in the server 10 can be reproduced by each audio client CL according to a different program schedule PS created for each floor. Then, different music pieces can be reproduced on different floors, while reproducing the same music piece on all floors for special time slots such as when the store opens and when it closes. Different music pieces are reproduced on different floors based on a plurality of program schedules PS, which can all be managed at the controller 20. As compared with conventional broadcasting equipment, it is possible with the network AV system 1 to realize the function of a broadcasting station more easily and inexpensively.

In the present embodiment, the controller 20 may be a separate component as shown in FIG. 1, or may alternatively be provided in the server 10 or the audio client CL. For example, if the controller application program 211 is installed on the hard disk 11 of the server 10, the server 10 will have the function of the controller 20. If the controller application program 211 is installed on the hard disk 30 of the audio client CL, the client CL will have the function of the controller 20.

### 2. Second Embodiment

When a network AV system is used as a broadcasting station in a department store, or the like, there may be cases where the user wishes to reproduce a special newscast, or the like, as a special program interrupting a regular program being reproduced. There may also be cases where the user wishes to reproduce a special music piece as a special program at the start time of a bargain sale, a special event, etc. With the network AV system of the present embodiment, such a special program can be reproduced by interrupting a regular program. The network AV system of the present embodiment will now be described. The term “regular program” as used in the present embodiment corresponds to the term “program” as used in the first embodiment.

2.1. Configuration

The controller 20 has program schedule information PSI1 as shown in Table 7 below, instead of program schedule information PSI1 as shown in Table 1. Other program schedule information PSI2 to PSIn are similar in data structure to the program schedule information PSI1 shown in Table 7.

TABLE 7
Program Schedule PS1
Program Schedule Information PSI1

| | |
|---|---|
| Program Schedule Name PSN | JPOP channel |
| Playlist ID | ID of playlist in which program is |
| | registered |
| Special Program Playlist ID | ID of playlist in which special program |
| | is registered |
| Current Program Number | program number 1 |
| Program List | program list PL1 |
| Next Special Program Number | special program number 1 |
| Special Program List | special program list SPL1 |

As compared with Table 1, the program schedule information PSI1 shown in Table 7 includes additional fields, i.e., “Special Program Playlist ID”, “Next Special Program Number” and “Special Program List”. The “Special Program Playlist ID” field stores the identifier of a special program playlist to be registered in the server 10. A special program playlist is a music list ML of a special program to be reproduced, and is stored in the memory 13 of the server 10. Thus, a music list ML of a special program is registered in the server 10 as a special program playlist separate from a music list ML of a regular program. The “Special Program List” field stores a special program list SPL1. Table 8 below shows the special program list SPL1.

TABLE 8
Special Program List SPL1

| | |
|---|---|
| Special Program Number 1 | special program information SPI1 |
| Special Program Number 2 | special program information SPI2 |
| Special Program Number 3 | special program information SPI3 |
| Special Program Number 4 | special program information SPI4 |
| . | . |
| . | . |
| . | . |
| Special Program Number i | special program information SPIi |

The special program list SPL1 is a list of special programs SPR. Referring to Table 8, the special program list SPL1 includes a plurality of items of special program information SPI1 to SPIi each associated with a special program number ranging from 1 to i (i is a natural number). The special program information SPI is a piece of information about a special program SPR.

Referring back to Table 7, the special program number of a special program SPR to be reproduced next is set in the “Next Special Program Number” field. For example, if a special program SPR2 whose special program number is 2 is being reproduced or has been reproduced, a program number of 3 is set in the “Next Special Program Number” field. Table 9 below shows the special program information SPI1.

TABLE 9
Special Program Information SPI1

| | |
|---|---|
| Reproduction Start Time ST | 15:00 |
| Program Status | not started, started, music list changed |
| Content Information | music list ML1 |

As compared with the program information PI1 shown in Table 3, the special program information SPI1 does not include the reproduction finish time FT. Unlike a regular program PR in which music pieces in a music list ML are repeatedly reproduced over a predetermined time slot, a special program SPR ends after music pieces in the music list ML are reproduced once. Therefore, the reproduction of a special program SPR can be properly controlled as long as the reproduction start time ST is specified. The controller 20 further includes the client data CD1 as shown in Table 10, instead of the client data CD1 as shown in Table 5.

TABLE 10
Client Data CD1

| | |
|---|---|
| Program Schedule | program schedule PS1 |
| Reproduction Status | reproducing SP, reproducing, stopped |
| Current Music Number | music number of regular program being |
| | reproduced |
| Last SP Music Number | last music number of special program |
| | reproduced |
| Flag | presence/absence of connection |
| Type | client |
| Status | current status |
| Volume | current volume |
| ProductID | product ID |
| FirmwareID | firmware ID |
| Hostname | client name |
| SongID | music ID |

The “Program Schedule” field of the client data CD1 of Table 10 stores a program schedule that is associated with the audio client CL1 (the program schedule PS1 in the example of Table 10).

The “Reproduction Status” field stores the reproduction status of the audio client CL1. The reproduction status being “reproducing” indicates that the audio client CL1 is reproducing a regular program PR. The reproduction status being “reproducing SP” indicates that the audio client CL1 is reproducing a special program SPR. The reproduction status being “stopped” indicates that neither a regular program PR nor a special program SPR is being reproduced.

When a regular program PR is being reproduced, the music number of a music piece being reproduced is set in the “Current Music Number” field. Even if a regular program PR is interrupted with a special program SPR resulting in the suspension of the reproduction of a music piece, the regular program PR can be resumed with the interrupted music piece after the completion of the special program SPR by referring to the “Current Music Number” field.

When a special program SPR is being reproduced, the music number of the last music piece reproduced is set in the “Last SP Music Number” field. The last SP music number is used when determining whether or not the reproduction of the special program SPR has been finished.

The “Flag” field of the client data CD1 indicates the presence/absence of a connection between the server 10 and the audio client CL1. The flag is set in the presence of a connection therebetween and reset in the absence thereof. The “Type” field indicates the type of the client device connected to the server 10. If the device connected to the server 10 is the audio client CL1, “audio client” is set in the client type field.

The “Status” field stores the current status of the audio client CL1, e.g., “reproduce” or “stop”. When the audio client CL1 starts reproducing a music piece, status data “start” is transmitted from the audio client CL1 to the controller 20 via the server 10. When the reproduction of a music piece is stopped, status data “stop” is transmitted to the controller 20. The controller 20 registers the received status data.

The “Volume” field represents the current volume value. The “ProductID” field represents the product ID (device type information) assigned to the device. The “FirmwareID” field represents the firmware ID indicating the version of the firmware installed on the audio client CL1. The “Hostname” field represents the client name assigned to the device. The “SongID” field represents the music ID for identifying a music piece being reproduced. As is the “status”, the “songID” is also transmitted from the audio client CL1 to the controller 20 via the server 10.

Other than this, the configuration of the network AV system 1 is the same as that of the first embodiment.

2.2. Operation

The connection process and the program schedule selection process of the network AV system 1 of the present embodiment are the same as those of the first embodiment (see 1.2.1. and 1.2.2.2.).

The controller 20 creates not only a regular program PR but also a special program SPR, and registers them in the program schedule PS. A special program SPR can be created and registered in the same manner as with a regular program PR. In other words, a special program SPR is created and registered in the special program list of the program schedule information PSI through the program schedule updating process described above in 1.2.2.1.

2.2.1. Program Instruction Process

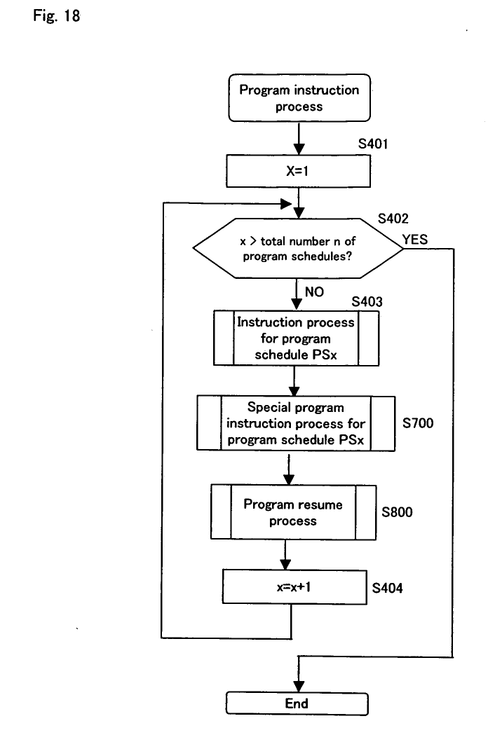

The controller 20 periodically performs the program instruction process. Referring to FIG. 18, the controller 20 of the present embodiment normally instructs the audio clients CL1 to CL3 to reproduce a regular program PR (S403: instruction process). When the current time reaches the reproduction start time ST of a special program SPR, the controller 20 gives an instruction to suspend the reproduction of the regular program PR and reproduce the special program SPR (S700: special program instruction process). After the completion of the special program, the controller 20 performs a program resume process (S800) for resuming the reproduction of the suspended regular program. Other than this, the operation is the same as that shown in FIG. 11. An example of the special program instruction process (step S700) and the program resume process (step S800) will now be described, assuming that counter x=1 (i.e., the program schedule PS1 is being reproduced).

2.2.2. Special Program Instruction Process

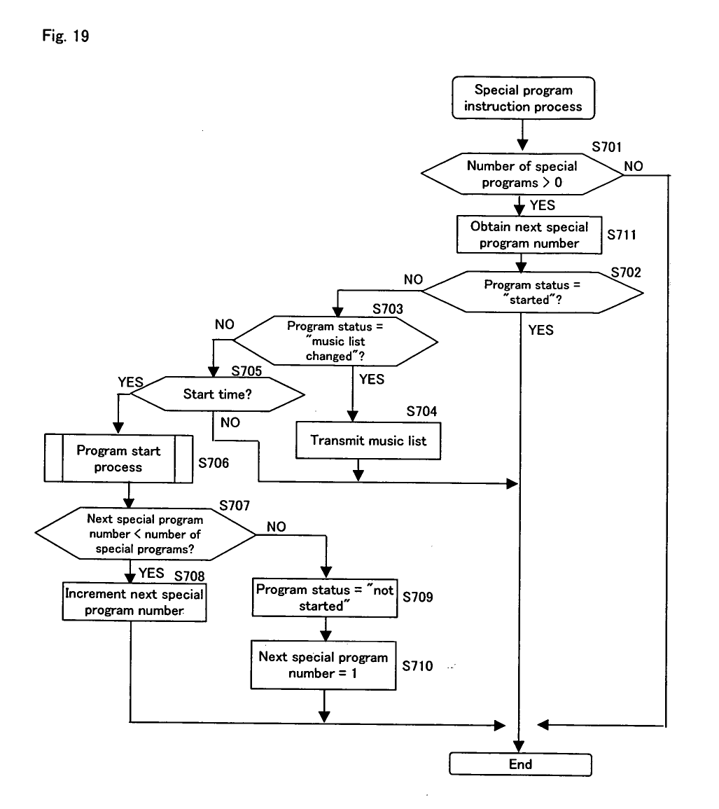

Referring to FIG. 19, if special program information SPI is registered in the special program list SPL1 (S701), the controller 20 obtains the next special program number from the program information PI1 (S711). If the next special program number is “program number 1”, the controller 20 checks the program status of the special program information SPI1 (S702).

If it is determined in step S702 that the program status is “started”, meaning that a special program SPR1 has been reproduced or is being reproduced, the controller 20 exits the special program instruction process.

If it is determined in step S703 that the program status is “music list changed”, meaning that the music list ML has been changed through the program schedule updating process (see 1.2.2.1.) while the special program SPR1 is being reproduced, the new music list ML together with the special program playlist ID are transmitted to the server 10 (S704). The server 10 registers the new music list in the special program playlist of the received special program playlist ID. Thus, the special program SPR1 can be reproduced based on the new music list ML.

If the program status is “not started”, the controller 20 determines whether or not to start the reproduction of the special program SPR1 (S705). If the current time is before the program start time ST of the special program information SPI1, the controller 20 does not start the reproduction of the special program SPR1, and exits the special program instruction process. If the current time reaches the program start time ST, the controller 20 performs the program start process (S706) and instructs the audio client CL to reproduce the special program SPR1.

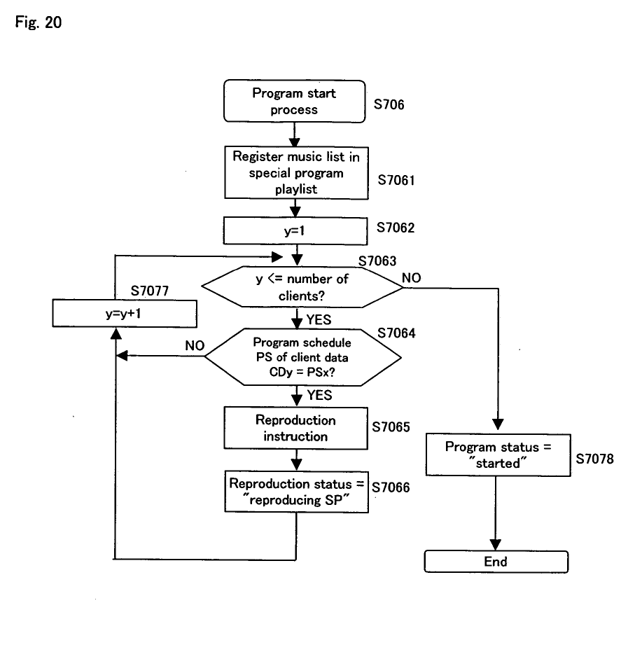

Referring to FIG. 20, the controller 20 transmits to the server 10 the music list ML of the special program information SPI1 together with the special program playlist ID (S7061). The server 10 registers the received music list ML in the special program playlist of the received special program playlist ID. Thus, the system is ready to suspend the regular program PR being reproduced and start the reproduction of the special program SPR1.

Then, the controller 20 gives an instruction to reproduce the special program SPR1 to all the audio clients CL that are reproducing the regular program PR based on the program schedule PS1 (S7062 to S7078). First, the controller 20 sets the counter y for the audio clients CL to 1 (S7062), and confirms that the number of audio clients CL in the network AV system 1 is equal to or greater than the counter y (S7063). Then, it is determined whether or not the audio client CLy (i.e., the audio client CL1) is performing a reproduction process based on the program schedule PS1 (S7064). If the value of the “Program Schedule” field of the client data CD1 is “program schedule PS1” (S7064), the controller 20 transmits a reproduction instruction to the audio client CL1 (S7065). The reproduction instruction include the special program playlist ID. Receiving the reproduction instruction, the audio client CL1 reproduces the special program SPR1. The reproduction process will be described later. After transmitting the reproduction instruction, the controller 20 sets the reproduction status of the client data CD1 to “reproducing SP” (S7066).

After the operation described above, the counter y is incremented. Thus, the determination as to whether or not to transmit an instruction to reproduce the special program SPR1 is made for all of the audio clients CL. After the determination is made for all of the audio clients CL, the controller 20 sets the program status of the special program information SPI1 to “started” (S7078). In other words, when the reproduction instruction has been given to all the audio clients CL that should reproduce the special program SPR1, the controller 20 confirms the start of the special program SPR1.

Referring back to FIG. 19, after the reproduction of the special program SPR1 is started through the program start process, the controller 20 prepares to give an instruction to reproduce the next special program (S707 to S710). First, the controller 20 determines whether or not all of the special programs SPR have been reproduced (S707). Specifically, the controller 20 determines whether or not the number of special programs in the special program list SPL1 is greater than the special program number (=1) of the program schedule information PSI1. If so, there is at least one un-reproduced special program SPR. Therefore, the controller 20 increments the next special program number of the program schedule information PSI1 to 2 (S708). The number of special programs being less than the special program number means that all of the special programs SPR for the day have been reproduced. Then, the controller 20 sets the program status of the special program information SPI1 to “not started” for all of the special programs SPR (S709), and sets the next special program number of the program schedule information PSI1 to 1 (S710), so that the system will be ready the next day to reproduce the special programs starting from the special program SPR1.

2.2.3. Program Resume Process

In a case where a regular program is suspended by an interruption with a special program, the program resume process is performed after the completion of the special program so as to resume the reproduction of the regular program starting from where it was suspended. Specifically, when a special program is reproduced, the music number of the regular program being interrupted by the special program is registered. After the reproduction of the special program is completed, the reproduction of the regular program is resumed starting from the registered music number.

The controller 20 performs the program resume process for all of the audio clients CL1 to CL3 in the network AV system 1. As an example, the program resume process for the audio client CL1 will now be described.

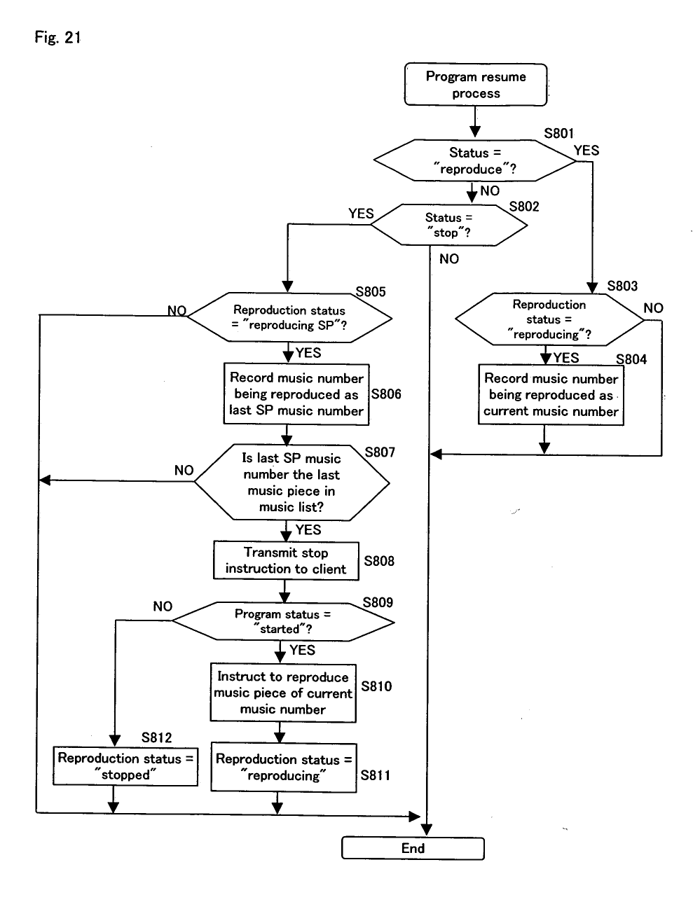

Referring to FIG. 21, where the audio client CL1 is reproducing a regular program PR, the audio client CL1 is reproducing music pieces based on the music list ML of the regular program PR. In this process, the controller 20 is monitoring the status data of the client data CD1 (S801 and S802). When the status data transitions from “stop” to “reproduce”, e.g., when the reproduction of the music data MD1 in the music list ML has been completed and the audio client CL1 starts reproducing the next music data MD2 (S801), the controller 20 determines whether or not the reproduction status of the client data CD1 is “reproducing” (S803). Since the audio client CL1 is reproducing the regular program PR, the program status is “reproducing”. Therefore, the controller 20 registers the music number 2 of the music data MD2 as the current music number in the client data CD1 (S804). The controller 20 can identify the music number 2 by identifying the music data MD2 based on the music ID transmitted from the audio client CL1.

Thus, during the reproduction of a regular program, the controller 20 constantly keeps registered in the client data CD1 the music number of the music piece being reproduced.

When the audio client CL1 reproduces the special program SPR1, the reproduction of the regular program PR is suspended, but the status remains “reproduce”. Therefore, “NO” is returned both in steps S801 and S802, and the process directly exits the program resume process. When the special program SPR1 is reproduced, the reproduction status of the client data CD1 is updated from “reproducing” to “reproducing SP” (see step S7066 in FIG. 20).

When the reproduction of the music piece whose music number is 1 in the special program SPR1 is completed, the status transitions from “reproduce” to “stop” (S802). At this point, since the reproduction status is “reproducing SP” (S805), the controller 20 registers the music number 1 of the music piece that has just been reproduced as the last SP music number in the client data CD1 (S806). The music number is identified based on the music ID. Then, the controller 20 determines whether or not the registered music number 1 is the last music number of the music list ML of the special program SPR1 (S807). If it is not the last music number, the controller 20 exits the program resume process.

When the reproduction of the last music piece in the special program SPR1 is completed, the controller 20 determines in step S807 that the music piece that has just been reproduced is the last music piece in the music list ML, and transmits to the audio client CL1 an instruction to stop the reproduction of the special program SPR1 (S808).

Then, the controller 20 identifies the program information PI of a regular program PR whose reproduction time slot includes the current time, and determines whether or not the program status of the identified program information PI is “reproduced” (S809). If it is “reproduced”, the controller 20 determines that the audio client CL1 reproduced the special program SPR1 while suspending the identified regular program PR. Therefore, the controller 20 instructs the audio client CL1 to reproduce the suspended regular program PR starting from the suspended music piece (S810). Specifically, the controller 20 transmits a reproduction instruction including a playlist ID and a current music number to the audio client CL1 via the server 10. Through this operation, the audio client CL1 resume the reproduction starting from the suspended music piece, as will be described later. After step S810, the controller 20 updates the reproduction status of the client data CD1 from “reproducing SP” to “reproducing” (S811), because the audio client CL1 is reproducing a regular program PR.

In step S809, the program status of the identified program information PI being not “started” means that the audio client CL1 started reproducing the special program SPR1 after the completion of the regular program PR. In other words, the audio client CL1 did not suspend the regular program PR for reproducing the special program SPR1. Therefore, the controller 20 updates the reproduction status from “reproducing SP” to “stopped” (S812). Thus, the controller 20 can transmit to the audio client CL1 an instruction to reproduce the regular program PR based on the instruction process of FIG. 12.

As described above, with the network AV system of the present embodiment, even if a regular program is being reproduced, it is possible to start reproducing a special program while suspending the regular program. Moreover, after the reproduction of the special program is completed, music pieces of the regular program can be reproduced starting from the suspended music piece.

2.2.4. Music Reproduction Process by Audio Client

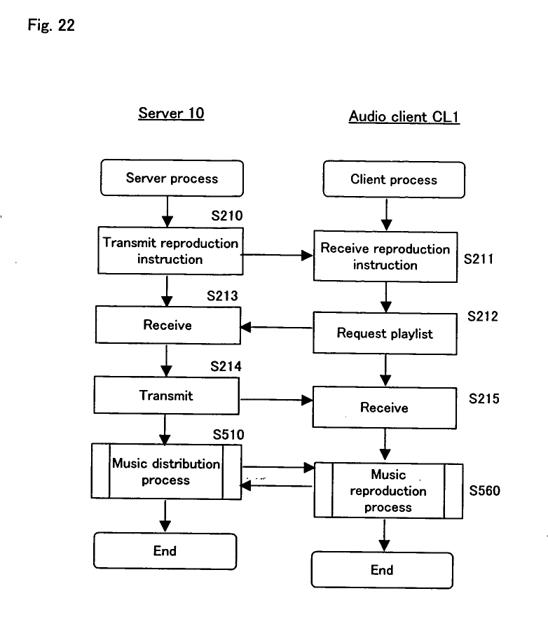

Referring to FIG. 22, the music reproduction operation by the audio client CL is the same as that shown in FIG. 15 except for the music reproduction process in step S560.

When the controller 20 transmits to the audio client CL an instruction to reproduce a regular program PR, the audio client CL requests a music list ML registered in the playlist ID (S212). When the controller 20 transmits an instruction to reproduce a special program SPR, the audio client CL1 requests a music list registered in the special program playlist ID (S212). The music reproduction process in step S560 will now be described.

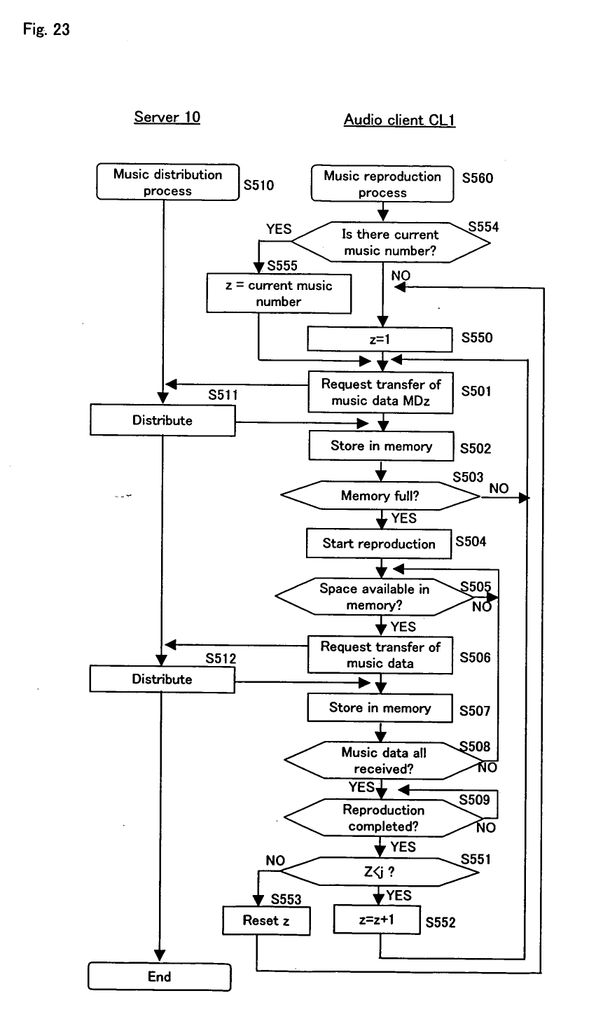

Referring to FIG. 23, the music reproduction process (S560) additionally includes steps S554 and S555 as compared with FIG. 16.

When the controller 20 transmits a reproduction instruction in step S810 in the program resume process, the reproduction instruction includes a current music number along with a playlist ID. Therefore, in step S554, the audio client CL determines that the reproduction instruction includes a current music number (S554). The audio client CL sets the counter z for music numbers to the received current music number (S555), and performs step S501 and subsequent steps. Thus, even if the reproduction of a regular program PR is interrupted by a special program SPR, the audio client CL can resume the reproduction of the regular program PR after the reproduction of the special program SPR is completed, starting from the interrupted music piece.

When a reproduction instruction including no current music number is received (S554), the process proceeds to step S550 to set the counter z to 1, and performs step S501 and subsequent steps. In other words, when an instruction to reproduce the special program SPR or an instruction to reproduce a regular program PR that has not been suspended is received, the audio client CL reproduces the program starting from the music piece whose music number is 1 in the music list ML registered in the special program playlist ID or the playlist ID that the audio client CL requested in step S212.

In step S504 of the music reproduction process, the audio client CL1 transmits status data “reproduce” to the controller 20 via the server 10. If it is determined in step S509 that the reproduction is completed, the audio client CL1 transmits the status data “stop” to the controller 20. Thus, the controller 20 can perform the program resume process based on the status data.

When a special program SPR is reproduced, the reproduction of the special program SPR is stopped after reproducing all music pieces in the music list ML once. In other words, music pieces in the music list ML are not repeatedly reproduced. Thus, an instruction to stop the reproduction of the special program SPR transmitted from the controller 20 in step S808 of FIG. 21 is received when the reproduction of the last music piece in the music list ML is completed.

While the content to be requested and distributed is music data in the first and second embodiments, it may alternatively be video data, AV data, picture data, etc.

While the present invention has been described above in preferred embodiments, it is understood that these embodiments are merely illustrative of how the invention may be carried out, and it is apparent to those skilled in the art that variations and modifications thereof can be made without departing from the spirit and scope of the invention.

1. A network AV system, comprising:
a server having a content storage section for storing a plurality of content items;
one or more clients connectable to the server;
a program schedule storage section for storing one or more program schedules each including a plurality of program information, the plurality of program information each including content information about a content item and a reproduction time slot associated with the content information;
an instruction section for giving an instruction to reproduce a content item according to the program schedule; and
one or more reproduction sections for reproducing the content item in response to the instruction,
wherein the server further includes a distribution section for distributing the content items to the one or more reproduction sections.

2. A network AV system according to claim 1, further comprising a section for associating a predetermined program schedule among the plurality of program schedules with one or more predetermined reproduction sections among the plurality of reproduction sections,
wherein the instruction section gives an instruction to reproduce a content item to the one or more predetermined reproduction sections associated with the program schedule.

3. A network AV system according to claim 2, further comprising:
a section for determining whether or not a current time is included in the reproduction time slot of a program schedule; and
a section for determining whether or not each reproduction section associated with the program schedule is performing a reproduction process,
wherein when it is determined that the current time is included in the reproduction time slot and the reproduction section is not performing a reproduction process, the instruction section gives an instruction to reproduce a content item according to the content information associated with the reproduction time slot.

4. A network AV system according to claims 1, further comprising:
a program information creating section for creating the program information; and
a program schedule registering section for registering the created program information in the program schedule.

5. A network AV system according to claim 4, further comprising a content information creating section for creating the content information by listing one or more selected content items among all the content items stored in the content storage section.

6. A network AV system according to claim 5, wherein the instruction section gives an instruction to reproduce the content items listed in the content information in an order the content items are listed.

7. A network AV system according to claim 1, wherein:
the program schedule further includes special program information including content information and a reproduction start time associated with the content information; and
when a current time has reached the reproduction start time, the instruction section gives an instruction to reproduce a content item according to content information that is associated with the reproduction start time, irrespective of whether or not the reproduction section is reproducing a content item according to content information that is associated with the reproduction time slot.

8. A network AV system according to claim 7, further comprising a completion determination section for determining whether or not the reproduction section has completely reproduced a content item based on content information that is associated with the reproduction start time,
wherein when the completion determination section determines that the content item has been completely reproduced, the instruction section gives an instruction to reproduce a content item according to content information whose reproduction time slot includes the current time.

9. A network AV system according to claim 8, wherein:
the content information is a list of content items;
the instruction section gives an instruction to reproduce the list of content items in an order the content items are listed;
the network AV system further comprises an identification section, wherein when the current time has reached the reproduction start time while the reproduction section is reproducing a content item according to content information whose reproduction time slot includes the current time, the identification section identifies the content item being reproduced by the reproduction section; and
if the completion determination section determines that the content item has been completely reproduced and if the current time is included in the reproduction time slot, the instruction section gives an instruction to successively reproduce content items starting from the identified content item.

10. A controller in a network AV system, the network AV system including a server storing a plurality of content items, one or more clients connectable to the server for reproducing the content items and the controller connectable to the server, the controller comprising:
a program schedule storage section for storing one or more program schedules each including a plurality of program information, the plurality of program information each including content information about a content item and a reproduction time slot associated with the content information; and
an instruction section for giving an instruction to reproduce a content item according to the program schedule.

11. A controller according to claim 10, further comprising a section for associating a predetermined program schedule among the plurality of program schedules with one or more predetermined clients among the plurality of clients,
wherein the instruction section gives an instruction to reproduce a content item to the one or more predetermined clients associated with the program schedule.

12. A controller according to claim 11, further comprising:
a section for determining whether or not a current time is included in the reproduction time slot of a program schedule; and
a section for determining whether or not each client associated with the program schedule is performing a reproduction process,
wherein when it is determined that the current time is included in the reproduction time slot and the client is not performing a reproduction process, the instruction section gives an instruction to reproduce a content item according to the content information associated with the reproduction time slot.

13. A controller according to claim 10, further comprising:
a program information creating section for creating the program information; and
a program schedule registering section for registering the created program information in the program schedule.

14. A controller according to claim 13, further comprising a content information creating section for creating the content information by listing one or more selected content items among all the content items stored in the server.

15. A controller according to claim 10, wherein:
the program schedule further includes special program information including content information and a reproduction start time associated with the content information; and
when a current time has reached the reproduction start time, the instruction section gives an instruction to reproduce a content item according to content information that is associated with the reproduction start time, irrespective of whether or not the client is reproducing a content item according to content information that is associated with the reproduction time slot.

16. A computer program product causing a controller in a network AV system, the network AV system including a server storing a plurality of content items, one or more clients connectable to the server for reproducing the content items and the controller connectable to the server, to perform the step of:
storing one or more program schedules each including a plurality of program information, the plurality of program information each including content information about a content item and a reproduction time slot associated with the content information; and
giving an instruction to reproduce a content item according to the program schedule.

17. A computer program product according to claim 16, further causing the controller to perform the step of associating a predetermined program schedule among the plurality of program schedules with one or more predetermined clients among the plurality of clients,
wherein the step of giving an instruction gives an instruction to reproduce a content item to the one or more predetermined clients associated with the program schedule.

18. A computer program product according to claim 17, further causing the controller to perform the step of determining whether or not a current time is included in the reproduction time slot of a program schedule; and
determining whether or not each client associated with the program schedule is performing a reproduction process,
wherein when it is determined that the current time is included in the reproduction time slot and the client is not performing a reproduction process, the step of giving an instruction gives an instruction to reproduce a content item according to the content information associated with the reproduction time slot.

19. A computer program product according to claim 16, further causing the controller to perform the step of
creating the program information; and
registering the created program information in the program schedule.

20. A computer program product according to claim 16, wherein:
the program schedule further includes special program information including content information and a reproduction start time associated with the content information; and
when a current time has reached the reproduction start time, the step of giving an instruction gives an instruction to reproduce a content item according to content information that is associated with the reproduction start time, irrespective of whether or not the client is reproducing a content item according to content information that is associated with the reproduction time slot.
